(19) United States
(12) Patent Application Publication
(10) Pub. No.: US 2006/0177644 A1
(43) Pub. Date: Aug. 10, 2006

(54) Cleaning material for molding die and method of cleaning therewith

(75) Inventors: Kiyohito Hiromitsu, Toyoma (JP); Hiroaki Nomura, Toyama (JP)

Correspondence Address: YOUNG & THOMPSON, 745 SOUTH 23RD STREET, 2ND FLOOR, ARLINGTON, VA, 22202, US

(73) Assignee: NIPPON CARBIDE KOGYO KABUSHIKI KAISHA, Tokyo (JP)

(21) Appl. No.: 10/560,816

(22) PCT Filed: Sep. 17, 2004
(86) PCT No.: PCT/JP04/13637

§ 371 Date: Dec. 15, 2005

(30) Foreign Application Priority Data
Sep. 29, 2003 (JP) 2003-336742
Jun. 9, 2004 (JP) 2004-170705
Jun. 9, 2004 (JP) 2004-171387

(51) Int. Cl. B08B 7/00; B08B 9/00; B32B 3/26; B32B 27/12

(52) U.S. Cl. 428/304.4; 134/6; 134/22.1; 134/19; 442/394

(57) ABSTRACT

A mold cleaning material of sheet form having an upper side and a lower side and including at least two base sheets and a cleaning member enclosed between the two base sheets. The base sheet on the upper side or as an outermost layer of the mold cleaning material is a fibrous sheet having a porosity of 70% or more, and the base sheet on the lower side is a fibrous sheet having a porosity of 40% or less and/or a heat-resistant film.

### TECHNICAL FIELD

The present invention relates to a mold cleaning material and a mold cleaning method for cleaning the surface of an injection or transfer molding die for electronic component encapsulation. More particularly it relates to a mold cleaning material and a mold cleaning method suitable for cleaning the surface of a mold die for sealing a substrate (e.g., a printed wiring board having chips built up thereon, hereinafter referred to as a printed circuit board) with a sealing resin.

### BACKGROUND ART

When encapsulation molding of integral circuits, etc. (hereinafter referred to as IC/LSIs) with a thermosetting resin such as an epoxy resin is continued for a long time, cases not infrequently occur in which the inner surface of the mold is stained, and continuation of molding with such a stained mold results in contamination of the surface of the molded products or adhesion of the molded product to the mold surface, making further shots impossible. The mold should be cleaned periodically, which is practiced by making a few shots with a mold cleaning resin per several hundreds of shots with a molding material thereby to remove deposited stubborn stain.

In the case of a mold for single side encapsulation composed of a lower mold (on which a printed circuit board is set by suction) and an upper mold for resin encapsulation, a dummy frame or a special jig having the same thickness as the printing circuit board is put on the lower mold by suction so that a cleaning material may not enter the suction holes of the lower mold during cleaning. Mold cleaning would be costly if the printed circuit board to be encapsulated, which is expensive, is used in carrying out mold cleaning.

### DISCLOSURE OF THE INVENTION

The conventional mold cleaning method using a special jig with the same thickness as a printed circuit board on the lower mold not only requires complicated operations for setting the jig and removing the cured resin together with the jig but also invites resin chipping readily, which makes the cleaning cycle time longer.

To address the above problems of related art, the present invention proposes using a mold cleaning material of sheet form comprising at least two base sheets and a cleaning member or a combination of a cleaning member and a molding member enclosed between the two base sheets. The cleaning material has a fibrous sheet having a porosity of 70% or more as an upper side base sheet or as an outermost layer of the upper side thereof and a fibrous sheet having a porosity of 40% or less and/or a heat-resistant film as a lower side base sheet.

The cleaning material of the present invention can easily be disposed in a lower mold and prevents a cleaning resin compound from clogging the suction holes of the lower mold by virtue of the lower side base sheet with low porosity. On heat and pressure application, the cleaning material allows the cleaning member (and the molding member) to pass through the upper fibrous base sheet with high porosity and to fill every part of the upper mold. Where a sealing member, such as film or tape, is used for enclosing the cleaning member between base sheets, the sealing member functions as a stopper against resin leakage. This advantage excludes the necessity to set the cleaning material in an accurately right position in the cavity of a mold, whereby the workability problem can be settled. Besides, the base sheet enhances the strength of a cured cleaning resin so that resin chipping that might occur on removal from the mold can be prevented.

The present invention thus provides a mold cleaning material of sheet form having an upper side and a lower side and comprising at least two base sheets and a cleaning member enclosed between the two base sheets, wherein the upper side base sheet or the outermost layer of the upper side is a fibrous sheet having a porosity of 70% or more, and the lower side base sheet of the cleaning material is at least one of a fibrous sheet having a porosity of 40% or less and a heat-resistant film.

The present invention also provides a method of cleaning a mold comprising the steps of inserting the mold cleaning material according to the invention between two halves of a heated mold, applying heat and pressure to the mold cleaning material for a predetermined time to cure the cleaning member, and removing the cleaning material from the mold.

According to the present invention, it is no more necessary to set a special jig having the same thickness as a printed circuit board on a lower mold so as to prevent a cleaning resin compound, etc. from entering suction holes for vacuum chucking. Since the cleaning material has a fibrous base sheet with a porosity of 70% or higher on the upper side and a fibrous base sheet having a porosity of 40% or less and/or a heat resistant film on the lower side, it is easily set between mold halves without clogging the lower mold's suction holes with the cleaning resin. On hot compression, the cleaning member (or a combination of the cleaning member and the molding member) is allowed to pass through the upper fibrous base sheet and fill every detail of the upper mold. Furthermore, the fibrous base sheet serves as a reinforcing filler in the cured material so that chipping of the cured cleaning resin hardly takes place.

### BRIEF DESCRIPTION OF THE DRAWINGS

FIG. 1 presents a cross-section and a see-through view of mold cleaning material A of sheet form prepared in Example 1.

FIG. 2 is a cross-section and a see-through view of mold cleaning material B of sheet form prepared in Example 2.

FIG. 3 is a cross-section and a see-through view of mold cleaning material C of sheet form prepared in Example 3.

FIG. 4 is a cross-section and a see-through view of mold cleaning material D of Example 4.

FIG. 5 is a cross-section and a see-through view of mold cleaning material E of sheet form prepared in Example 5.

FIG. 6 is a cross-section and a see-through view of mold cleaning material F of sheet form prepared in Example 6.

FIG. 7 is a cross-section and a see-through view of mold cleaning material G of sheet form prepared in Comparative Example 1.

### THE BEST MODE FOR CARRYING OUT THE INVENTION

The fibrous sheets that can be used in the invention include paper, woven fabric, and nonwoven fabric, each having heat resistance of 100° C. or higher. Taking ease of waste disposal, such as incineration, into consideration, fibrous base sheets made of paper, cotton woven fabric, etc. are preferred. Meshes made of yarns are also preferably used.

Examples of the base sheets include Bemlieseâ P0500, BA832, 832R, BA112, 112R, RB119, 142, 149, and 839 (available from Asahi Kasei Fibers Corp.); Eculeâ 6301A, 6401A, 6501A, 6601A, 6701A, and 6A01A and Volansâ 4050P, 4061P, 4080P, 4081P, 4091P, 7093P, and 7121P (available from Toyobo Co., Ltd.); Miracle Clothâ DF-1-73 and DF-5-100 and Apitasâ RPN5-60SA and LS-70 (available from Daiwabo Co., Ltd.); Marixâ 10606WTD, 70500WSO, 90403WSO, 20451FLV, 20707WTA, and 70600WTO, Nyaceâ P0703WTO, and WiWiâ R0405WTO and R0705WTO (available from Unitika, Ltd.); Kinoclothâ KS40, K60, and K70 and Palclothâ P40 and P60 (available from Oji Kinocloth Co., Ltd.); Panelonâ 2610, 270, 6810, K550, 5130, S30off, 3700, RF860, 7330GP, 5140, 5150, 5160, FT500, FT800, TO510, and IH250 (available from Dynic Corp.); Oikosâ AP2050, AP2060, AP2080, AP2120, AM2060, AK2045, TDP2050, and TDP2060 (available from Nisshinbo Industries, Inc.); and 4000CR, PS-750CR, 8890CR, WE-60CR, H-8010E, JH-3003N, HP21, and HP55 (available from Japan Vilene Co., Ltd.).

Examples of the fibrous base sheets with a porosity of 70% or more are Bemlieseâ P0500, BA832, 832R, BA112, 112R, RB119, 142, 149, and 839 (from Asahi Kasei Fibers Corp.); Eculeâ 6301A, 6401A, 6501A, 6601A, 6701A, and 6A01A and Volansâ 4050P, 4061P, 4080P, 4081P, 4091P, 7093P, and 7121P (from Toyobo Co., Ltd.); Panelonâ 2610, 270, 6810, K550, 5130, S30off, 3700, RF860, TO510, and IH250 (from Dynic Corp.); Oikosâ AP2050, AP2060, AP2080, AM2060, AK2045, TDP2050, and TDP2060 (from Nisshinbo Industries, Inc.); and HP21 and HP55 (from Japan Vilene Co., Ltd.).

These fibrous base sheets are capable of allowing the cleaning member and the molding member to fill throughout the mold without requiring a number of holes made therethrough. Having no holes, they have strength not to tear or break when removed after cleaning.

The fibrous sheet with a porosity of 40% or less that is used on the lower side of the cleaning material can easily be obtained by compressing existing nonwoven fabric having a porosity higher than 40% (e.g., the above described fibrous sheet with a porosity of 70% or higher) on a press, etc.

The heat resistant film with a porosity of 40% or less that can be used on the lower side of the cleaning material is suitably a resin film having heat resistance of 150° C. or higher, preferably 200° C. or higher.

A laminate sheet composed of the fibrous base sheet and the heat resistant film is also useful as a lower base sheet. Since the fibrous base sheet with a porosity of 40% or less easily loses its thickness on being compressed, a stack of a plurality of the fibrous base sheets may be used on the lower side.

Although the size of the base sheets is not particularly limited, it is advisable to use base sheets slightly larger than the mold area in case the resin leaks from air vents, etc. during cleaning. Even if the resin leaks, it would be absorbed by the margin of the base sheets, and the time required for clearing the leaked resin can be reduced.

The size of the margin is not generally specified because the resin's penetrability into the base sheet varies depending on the base sheet/resin combination. Nevertheless a recommended margin is about 5 cm or wider from the edge of the mold, taking the workability after cleaning operation into consideration.

The cleaning member has at least one form selected from a tablet form, a granular form, a powder form, a sheet form, and a plate form. The cleaning member may be enclosed in between two cut base sheets or in a bag made by folding a single sheet at least twice as large as the mold area into two. When the cleaning member is sealed in between two cut sheets, it is advisable to place a base sheet with a porosity of 70% or higher on the upper side, and a base sheet which is leakproof on the lower side.

At least one sealing member selected from a thermoplastic resin film, a thermoplastic resin tape, a double sided tape, an adhesive, a pressure-sensitive adhesive, etc. may be applied to a prescribed part of one or more of the base sheets.

The thermoplastic resin film or tape can be applied to the base sheet by any method. For example, the base sheet is laminated with a thermoplastic resin film, or a thermoplastic resin tape of given width is stuck to the base sheet, or the base sheet is laminated with a thermoplastic resin film whose central portion of moderate size has been cut out.

The base sheets may be adhered together by pressing or deforming without using any sealing member.

The method of enclosing a cleaning member is not particularly limited. For example, a thermoplastic resin film is applied to a prescribed part of a lower base sheet, and a given weight of a cleaning member having at least one of a tablet form, a granular form, a powder form, a sheet form, and a plate form is put on the lower base sheet in the part not covered with the thermoplastic resin film. Another base sheet (upper base sheet) having the same shape as the lower one is superposed thereon. The superposed base sheets are heat sealed together taking care not to move the cleaning member disposed therebetween.

It is preferred that the part where the cleaning member is to be placed be divided into sections having a moderate area so that the cleaning member may not move during transportation.

A base sheet with a double sided adhesive tape, an adhesive, a pressure-sensitive adhesive, etc. applied to a prescribed part thereof over a moderate area may also be used to enclose the cleaning member.

Where the cleaning member is sealed (enclosed) by adhering the base sheets either with a double sided tape, an adhesive, a pressure-sensitive adhesive, etc. or by heat sealing via a thermoplastic resin film or tape, it is preferred to apply the sealing member around the cleaning member as well as to the edges of the base sheets, whereby the cleaning member is double sealed. Should the inner sealing member melt to allow the cleaning member to flow out, it will be held back by the outer sealing member and thereby prevented from leaking.

The cleaning member used in the present invention mainly comprises a melamine resin. A melamine resin is a resin obtained by methylolating a triazine, e.g., melamine, with formaldehyde, etc. A melamine-formaldehyde resin is usually used.

A melamine-formaldehyde resin is generally produced in the form of an aqueous solution. A powdered cleaning member is obtained by drying the aqueous solution by, for example, spray drying. A granular cleaning member is obtained by blending the aqueous solution with pulp followed by drying. A tablet-shaped cleaning member is obtained by punching the powdered or granular resin.

A cleaning member of sheet form is obtained by impregnating a base sheet with the melamine-formaldehyde resin aqueous solution followed by drying. A cleaning member of plate form is obtained by compressing the powdered or granular cleaning material in a tableting machine.

The impregnation is achieved by dipping the base sheet in the melamine-formaldehyde resin aqueous solution and drying the impregnated base to give a cleaning member of sheet form. The impregnation ratio of the resin into the base can be adjusted as desired by, for example, altering the material of the base sheet, adjusting the resin solution concentration, or controlling the degree of squeezing off the resin. The impregnation ratio is also adjustable by controlling the curability or flowability of the resin.

The powdered or granular cleaning member may be mixed with additives (such as a lubricant, mineral powder, and a curing catalyst) by means of a kneader, a ribbon blender, a Henschel mixer, a ball mill, etc. The resulting mixed powder or granules can be punched into tablets.

The cleaning member of sheet or plate form can be cut to shape, including squares, rectangles, strips, and other shapes, on use. A cut piece which has a high impregnation ratio can be used alone or as combined with another one or two. Several cut pieces which have a low impregnation ratio can be used as stacked on top of each other.

The cleaning member can be shaped to the shape of a mold or can be disposed so as to efficiently fill the cavity and the pot with the resin.

Use of the cleaning member of sheet or plate form makes it feasible to dispose the resin more uniformly in a mold and to prevent incomplete fill.

After a cleaning shot with the mold cleaning material enclosing a cleaning member therein, the base sheets are embedded in a molded product. Therefore, the base sheets have the same effect as a filler enhancing the strength of a molded product. Commercially available cleaning members contain pulp for increasing the molded product strength. Replacement of pulp with the base sheet brings about increased bonding strength between a filler and a molded product, leading to increased strength of a molded product. Sufficient resin penetrability can be secured by using a fibrous base sheet with a porosity of 70% or more as an outermost layer. A combined use of the base sheet with a filler further improves the molded product strength. The improved molded product strength provides a resolution to the chipping problem arising from the stronger bonding force between a mold and mold stains than the molded product strength. As a result, workability as well as cleaning performance is improved.

The cleaning material of the present invention can contain a molding member selected from unvulcanized synthetic rubber and unvulcanized natural rubber in addition to the cleaning member of tablet, granular, powder, sheet or plate form.

The synthetic rubber includes, but is not limited to, butyl rubber, acrylic rubber, silicone rubber, polybutadiene, polyisoprene, a styrene-butadiene copolymer, a styrene-isoprene copolymer, an acrylonitrile-butadiene copolymer, an ethylene-a-olefin copolymer, an ethylene-a-olefin-polyene copolymer, a styrene-butadiene-styrene block copolymer, a styrene-isoprene-styrene block copolymer, a hydrogenated styrene-ethylene-butylene-styrene block copolymer, and an ethylene-based ionomer.

The unvulcanized synthetic or natural rubber exhibits moderate viscoelasticity when heat melted. It is a member having an important function of moving the upper and the lower base sheets toward the upper and the lower sides of a mold when the mold is clamped. This function brings the base sheets close to the cavity surface thereby reducing chipping that tends to occur in the corners or the air vent of the cavity. The function also improves filling of the cavity with the resin thereby eliminating such defects as incomplete fill resulting from insufficient flowability of the cleaning resin or insufficient pressure during cleaning.

### EXAMPLES

The present invention will now be illustrated in greater detail with reference to Examples, but it should be understood that the invention is not limited thereto. Unless otherwise noted, all the percents and parts are by weight.

### Referece Example 1

A melamine-formaldehyde resin was synthesized by a heat reaction between 480 parts of melamine and 522 parts of formalin (37% aqueous solution) in a known manner. The resulting resin solution was kneaded with 248 parts of pulp, and the mixture was dried under reduced pressure to obtain a pulp-loaded melamine-formaldehyde resin, which was roughly ground in a shear grinder to prepare melamine-formaldehyde resin granules.

### Preparation Example 1

Sixty parts of the pulp-loaded melamine-formaldehyde resin granules obtained in Reference Example 1, 40 parts of a commercially available melamine resin (Nikaresin S-176, available from Nippon Carbide Industries, Co., Inc.), 0.5 parts of benzoic acid, and 0.5 parts of zinc stearate were mixed and ground in a ball mill to prepare a mold cleaning resin compound. The resulting compound was compressed on a tableting machine to prepare plate-shaped cleaning member X of 150 mm in width, 200 mm in length, and 4 mm in thickness.

### Preparation Example 2

The plate-shaped cleaning member X obtained in Preparation Example 1 was ground in a crusher and sieved to remove fine particles to prepare granular cleaning member Y.

### Preparation Example 3

A hundred parts of an ethylene-propylene-diene rubber having a Mooney viscosity of 15 and 10 parts of oil mainly comprising petroleum hydrocarbons were kneaded in a pressure kneader for 10 minutes. The resulting mass was extruded from a twin-screw extruder into sheeting, which was rolled to prepare sheet molding member Q having a width of 150 mm and a thickness of 3 mm.

### Example 1

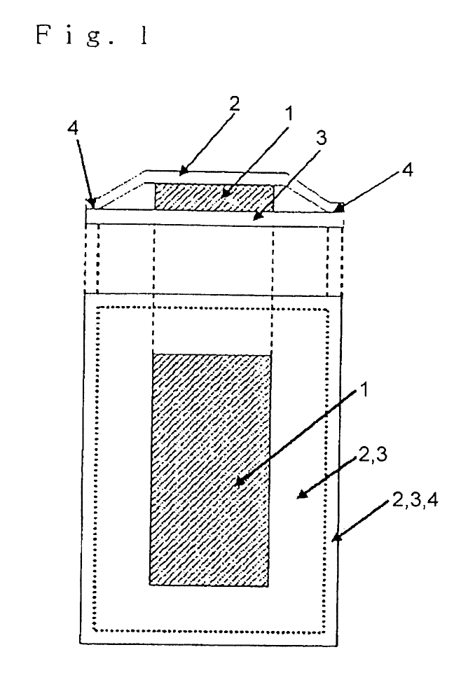

The sheet-shaped cleaning member X obtained in Preparation Example 1 was placed on the center of a 200 mm wide, 300 mm long, and 100 μm thick polyethylene terephthalate (PET) film. A 200 mm wide and 300 mm long fibrous base sheet of HP21 (available from Japan Vilene Co., Ltd.) was superposed on the PET film to sandwich the cleaning material X therebetween. The laminate was pressed at 80° C. to fix the cleaning member X. The two base sheets were heat sealed along the four side edges to obtain mold cleaning material A of sheet form shown in FIG. 1.

The resulting mold cleaning material A was subjected to a mold cleaning test (described later). The results obtained are shown in Table 1. As can be seen from the results, the mold cleaning material A showed satisfactory cleaning effects.

### Example 2

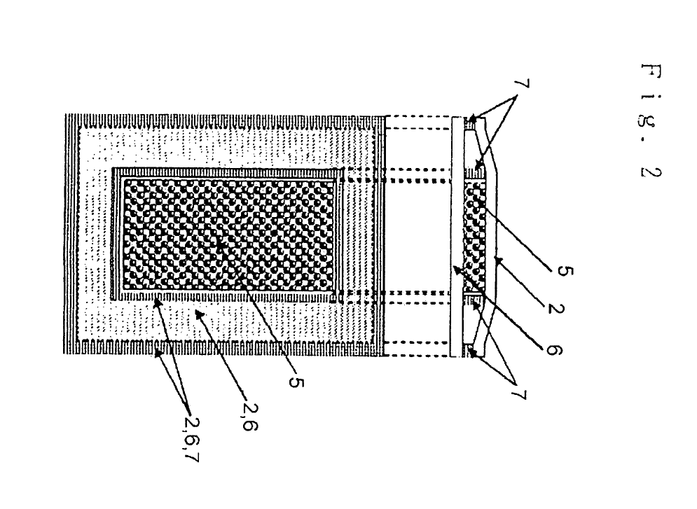

A nonwoven cotton fabric (Bemliese BA112, from Asahi Kasei Fibers Corp.) was compressed to reduce the porosity to 40% or less. The compressed Bemliese BA112 was cut to a width of 200 mm and a length of 300 mm, and two cut sheets were stacked. Intact Bemliese BA112 (porosity: 85%) cut to the same size was placed thereon. The three sheets were joined by hot melting a thermoplastic resin tape applied along the position 25 mm inward from each of the three edges (heat sealing). The section defined by the compressed Bemliese BA112, the intact Bemlise BA112, and the heat seal was filled with the granular cleaning member Y prepared in Preparation Example 2 and heat sealed along the position 25 mm inward from the remaining open edge in the same manner as described above thereby to enclose the granules. The four edges of the three sheets were then heat sealed via a thermoplastic resin tape to obtain mold cleaning material B of sheet form shown in FIG. 2. The resulting cleaning material B was evaluated in the same manner as in Example 1. The results obtained are shown in Table 1. The mold cleaning material B proved to be satisfactory in cleaning effects.

### Example 3

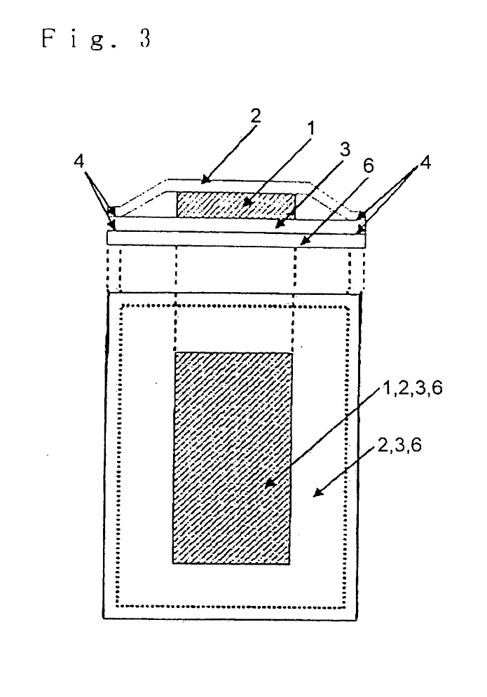

A nonwoven fabric (Volans 4091P, from Toyobo Co., Ltd.) was compressed to reduce the porosity to 40% or less and cut to width of 200 mm and a length of 300 mm. A 75 μm thick PET film of the same size was superposed thereon. The plate-shaped cleaning material X obtained in Preparation Example 1 was put on the center of the PET film. A cut sheet of intact Volans 4091P (porosity: 94%) of the same size was superposed thereon to sandwich the cleaning material X. The laminate was pressed at 80° C. to fix the cleaning member X onto the PET film. The four side edges of the laminate were heat sealed to obtain mold cleaning material C of sheet form shown in FIG. 3.

The resulting mold cleaning material C was evaluated in the same manner as in Example 1. The results obtained are shown in Table 1. As can be seen from the results, the mold cleaning material C showed satisfactory cleaning effects.

### Example 4

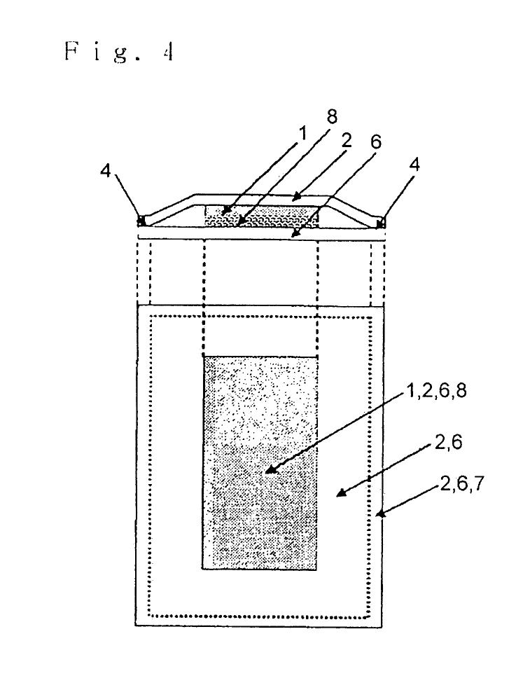

A nonwoven fabric (Bemliese BA 112, from Asahi Kasei Fibers Corp.) was compressed to reduce the porosity to 40% or less. The compressed Bemliese BA112 was cut to a width of 200 mm and a length of 300 mm. The sheet molding member Q prepared in Preparation Example 3 was put on the center of the sheet. The plate-shaped cleaning member X obtained in Preparation Example 1 was superposed on the molding member Q. Intact Bemliese BA112 (porosity: 85%) cut to the same size as the lower Bemliese sheet was placed thereon, and the stack was pressed at 80° C. to fix the sheets and the members. The four edges of the upper and lower sheets were heat sealed to obtain mold cleaning material D of sheet form shown in FIG. 4. The resulting cleaning material D was evaluated in the same manner as in Example 1. The results obtained are shown in Table 1. The mold cleaning material D proved to be satisfactory in cleaning effects.

### Example 5

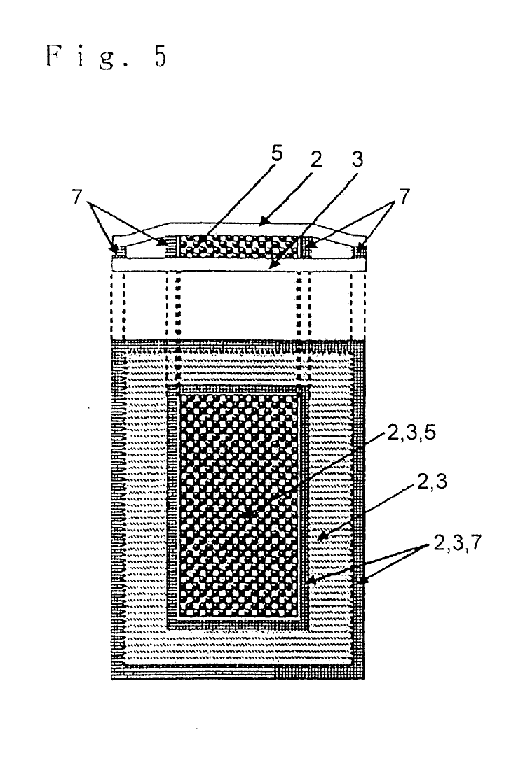

A 200 mm wide and 300 mm long fibrous base sheet of Bemliese BA112 (from Asahi Kasei Fibers Corp.; porosity: 85%) was superposed on a 100 μm thick PET film of the same size. The two sheets were joined by hot melting a thermoplastic resin tape applied along the position 25 mm inward from each of the three edges (heat sealing). The section defined by the two sheets and the heat seal was filled with the granular cleaning member Y prepared in Preparation Example 2, and the two sheets were heat sealed along the position 25 mm inward from the remaining open edge in the same manner as described above thereby to enclose the granules between the two sheets. The four edges of the two sheets were then heat sealed via a thermoplastic resin tape to obtain mold cleaning material E of sheet form shown in FIG. 5. The resulting cleaning material E was evaluated in the same manner as in Example 1. The results obtained are shown in Table 1. The mold cleaning material E proved to be satisfactory in cleaning effects.

### Example 6

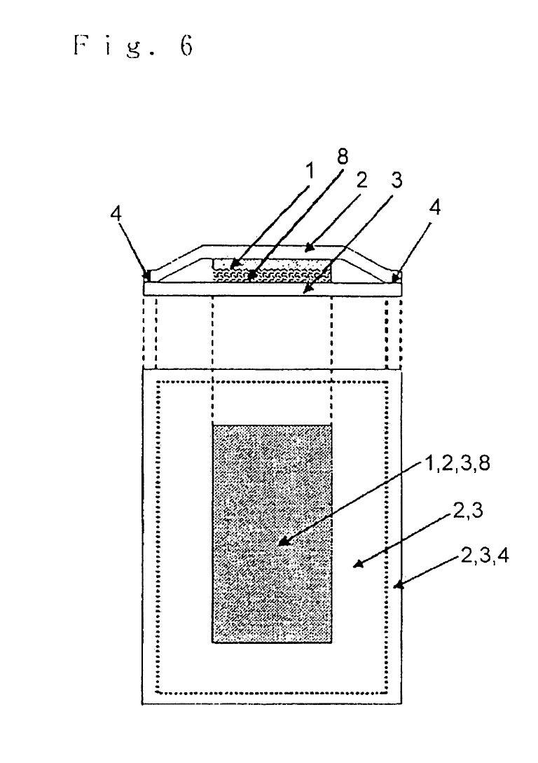

The sheet molding member Q obtained in Preparation Example 3 was disposed on the center of a 200 mm wide, 300 mm long, and 100 μm thick PET film. The plate-shaped cleaning member X obtained in Preparation Example 1 was put on the sheet molding member Q. A cut sheet of Bemliese BA112 (from Asahi Kasei Fibers Corp.; porosity: 85%) of the same size as the PET film was superposed thereon, and the stack was pressed at 80° C. to fix the members and the sheets. The four edges of the lower and upper sheets were heat sealed to obtain mold cleaning material F of sheet form shown in FIG. 6. The resulting cleaning material F was evaluated in the same manner as in Example 1. The results obtained are shown in Table 1. The mold cleaning material F proved to be satisfactory in cleaning effects.

### Comparative Example 1

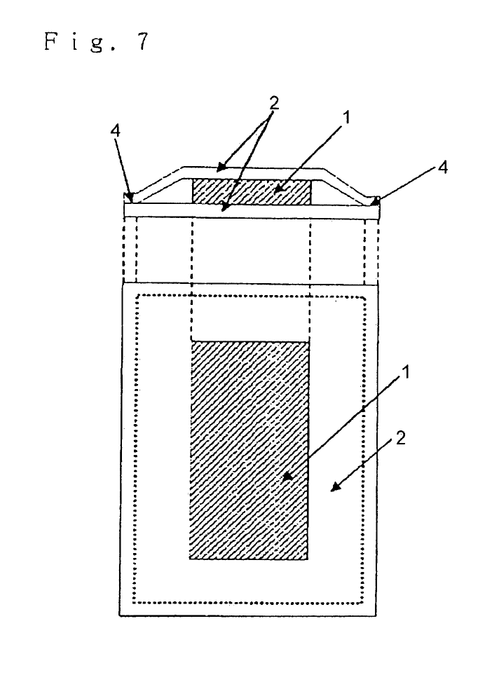

Mold cleaning material G shown in FIG. 7 was made in the same manner as in Example 1, except for replacing the lower heat-resistant PET film with a sheet of HP21 (from Japan Vilene Co., Ltd.; porosity: 94%). The cleaning test results of mold cleaning material G are shown in Table 1.

In FIGS. 1 through 7, numeral 1 indicates plate-shaped cleaning member X; 2, a fibrous base sheet with a porosity of 70% or higher; 3, a heat-resistant film; 4, a heat seal; 5, granular cleaning member Y; 6, a fibrous base sheet with a porosity of 40% or less; 7, a thermoplastic resin tape; and 8, sheet molding member Q.

The mold cleaning materials A to G of sheet form were subjected to the below mentioned mold cleaning test. The results are shown in Table 1.

Cleaning Test Method:

Five hundred shots of a commercially available biphenyl epoxy resin molding compound (CEL-9200XU, available from Hitachi Chemical Co., Ltd.) were made in a multi-cavity mold for QFN packaging to create mold stain. The mold cleaning material was repeatedly molded in the stained mold until the mold surface was cleared of the stain. The workability of the cleaning material was evaluated in terms of an average time required for removing the molded product per cavity.

The capabilities of filling the cavities with the cleaning resin compound (cavity filling capabilities) were evaluated by the percentage of the number of upper cavity halves that were completely filled with the resin compound to the total number of the upper cavity halves.

The anti-chipping properties were evaluated by the number of chippings in the cavities.

TABLE 1

| | Example | | | | | | Compara. |
|---|---|---|---|---|---|---|---|
| | 1 | 2 | 3 | 4 | 5 | 6 | Example 1 |
| Cleaning Material | A | B | C | D | E | F | G |
| Porosity of | 94/0 | 85/33 | 94/0/ | 85/33 | 85/0 | 85/0 | 94/94 |
| Base Sheets* (%) | | | 38 | | | | |
| Presence of Heat- | yes | no | yes | no | yes | yes | no |
| Resistant Film | | | | | | | |
| Mold Temp. | 175 | 175 | 175 | 175 | 175 | 175 | 175 |
| (° C.) | | | | | | | |
| Curing Time (sec) | 180 | 180 | 180 | 180 | 180 | 180 | 180 |
| Average Time | 5 | 5 | 5 | 5 | 5 | 5 | 48 |
| for Removal (sec) | | | | | | | |
| Cavity Filling | 100 | 100 | 100 | 100 | 100 | 100 | 89 |
| Properties (%) | | | | | | | |
| Number of | 0 | 0 | 0 | 0 | 0 | 0 | 5 |
| Chippings | | | | | | | |

*In the order of from upper to lower base sheets.

### INDUSTRIAL APPLICABILITY

The mold cleaning material of the invention is capable of easily and efficiently cleaning a mold die for single-side encapsulation having suction holes in the lower mold because it is no more necessary to pre-set an expensive printed circuit board or a dummy jig on the lower mold. Since the cleaning resin is prevented from entering the suction holes, incomplete mold fill due to resin leakage does not occur, and a molded product is easily stripped off the mold. The fibrous base sheet having a porosity of 70% or more used on the side facing the upper mold allows the cleaning member to fill every part of the mold while retaining the strength as a base sheet. For all of these reasons, the molding cleaning material of the present invention exhibits excellent mold cleaning performance and workability.

1.-9. (canceled)

10. A mold cleaning material of sheet form having an upper side and a lower side and comprising at least two base sheets and a cleaning member enclosed between the two base sheets, wherein the base sheet on the upper side or the outermost layer of the upper side is a fibrous sheet having a porosity of 70% or more, and the base sheet on the lower side is at least one of a fibrous sheet having a porosity of 40% or less and a heat-resistant film.

11. The mold cleaning material according to claim 10, further comprising a molding member enclosed between the two base sheets.

12. The mold cleaning material according to claim 11, wherein the molding member is at least one of unvulcanized synthetic rubber and unvulcanized natural rubber.

13. The mold cleaning material according to claim 10, which is for cleaning a mold for single-side encapsulation of a substrate.

14. The mold cleaning material according to claim 10, wherein the cleaning member has at least one of a tablet form, a granular form, a powder form, a plate form, and a sheet form.

15. The mold cleaning material according to claim 10, wherein a thermoplastic resin film or tape is applied to at least a part of the surface of at least one of the base sheets, and the cleaning member or a combination of the cleaning member and the molding member is enclosed by heat sealing the at least two base sheets via the thermoplastic resin film or tape or by coating and laminating the at least two base sheets with the thermoplastic resin film or tape.

16. The mold cleaning material according to claim 10, wherein the cleaning member or a combination of the cleaning member and the molding member is enclosed by partly adhering the at least two base sheets with at least one of a double-sided tape, an adhesive, and a pressure sensitive adhesive.

17. The mold cleaning material according to claim 10, wherein the cleaning member or a combination of the cleaning member and the molding member is enclosed by partly adhering the at least two base sheets by pressing or deforming the at least two base sheets.

18. A method of cleaning a mold comprising the steps of inserting the mold cleaning material according to claim 10 between two halves of a heated mold, applying heat and pressure to the mold cleaning material for a predetermined time to cure the cleaning member, and removing the cleaning material from the mold.

19. The mold cleaning material according to claim 11, which is for cleaning a mold for single-side encapsulation of a substrate.

20. The mold cleaning material according to claim 12, which is for cleaning a mold for single-side encapsulation of a substrate.

21. The mold cleaning material according to claim 11, wherein the cleaning member has at least one of a tablet form, a granular form, a powder form, a plate form, and a sheet form.

22. The mold cleaning material according to claim 12, wherein the cleaning member has at least one of a tablet form, a granular form, a powder form, a plate form, and a sheet form.

23. The mold cleaning material according to claim 13, wherein the cleaning member has at least one of a tablet form, a granular form, a powder form, a plate form, and a sheet form.

24. The mold cleaning material according to claim 11, wherein a thermoplastic resin film or tape is applied to at least a part of the surface of at least one of the base sheets, and the cleaning member or a combination of the cleaning member and the molding member is enclosed by heat sealing the at least two base sheets via the thermoplastic resin film or tape or by coating and laminating the at least two base sheets with the thermoplastic resin film or tape.

25. The mold cleaning material according to claim 12, wherein a thermoplastic resin film or tape is applied to at least a part of the surface of at least one of the base sheets, and the cleaning member or a combination of the cleaning member and the molding member is enclosed by heat sealing the at least two base sheets via the thermoplastic resin film or tape or by coating and laminating the at least two base sheets with the thermoplastic resin film or tape.

26. The mold cleaning material according to claim 13, wherein a thermoplastic resin film or tape is applied to at least a part of the surface of at least one of the base sheets, and the cleaning member or a combination of the cleaning member and the molding member is enclosed by heat sealing the at least two base sheets via the thermoplastic resin film or tape or by coating and laminating the at least two base sheets with the thermoplastic resin film or tape.

27. The mold cleaning material according to claim 14, wherein a thermoplastic resin film or tape is applied to at least a part of the surface of at least one of the base sheets, and the cleaning member or a combination of the cleaning member and the molding member is enclosed by heat sealing the at least two base sheets via the thermoplastic resin film or tape or by coating and laminating the at least two base sheets with the thermoplastic resin film or tape.

28. The mold cleaning material according to claim 11, wherein the cleaning member or a combination of the cleaning member and the molding member is enclosed by partly adhering the at least two base sheets with at least one of a double-sided tape, an adhesive, and a pressure sensitive adhesive.

29. The mold cleaning material according to claim 12, wherein the cleaning member or a combination of the cleaning member and the molding member is enclosed by partly adhering the at least two base sheets with at least one of a double-sided tape, an adhesive, and a pressure sensitive adhesive.
